(19) United States
(12) Patent Application Publication
(10) Pub. No.: US 2025/0128910 A1
(43) Pub. Date: Apr. 24, 2025

(54) ELEVATOR SYSTEM AND ELEVATOR CAR ASSIGNMENT METHOD

(71) Applicant: Mitsubishi Electric Corporation, Tokyo (JP)

(72) Inventor: Yuya SENGOKU, Tokyo (JP)

(73) Assignee: Mitsubishi Electric Corporation, Tokyo (JP)

(21) Appl. No.: 18/685,514

(22) PCT Filed: Jan. 7, 2022
(86) PCT No.: PCT/JP2022/000415

§ 371 Date: Feb. 22, 2024

(51) Int. Cl. B66B 1/24; B66B 17/20

(52) U.S. Cl. CPC B66B 1/2466; B66B 17/20; B66B 2201/103; B66B 2201/21; B66B 2201/22; B66B 2201/23; B66B 2201/235; B66B 2201/24; B66B 2201/241; B66B 2201/4615; B66B 2201/4623; B66B 2201/463

(57) ABSTRACT

An elevator system is configured to be capable of accepting an internal call made by a user operating an elevator operating panel and an external call made from an external apparatus using a communication network. The elevator system is provided with a processor that assigns a car to be an arranged-car candidate to an internal call or an external call from among one or more cars. The processor is configured to, when an external call is accepted, execute an operation condition judgment process for judging whether each of the one or more cars is in an operating state or in a non-operating state and an external call assignment process for preferentially assigning a car in the non-operating state as the arranged-car candidate over a car in the operating state.

### FIELD

The present disclosure relates to an elevator system and an elevator car assignment method.

### BACKGROUND

In PTL 1, a technique about control of an elevator that is allowed to be shared by an autonomous mobile robot and users is disclosed. In this technique, a call signal that is wirelessly transmitted by the autonomous mobile robot is registered. When the autonomous mobile robot rides on a riding car, and calls by users in the same direction as a destination floor of the autonomous mobile robot are made, responses to the calls by the users are preferentially made. Then, when there are no calls by users, the operation is switched to dedicated operation to the destination floor of the autonomous mobile robot. When it is confirmed that the autonomous mobile robot has got off at the destination floor, normal operation is recovered.

### CITATION LIST

### Patent Literature

[PTL 1] JP 2020-14763 A

### SUMMARY

### Technical Problem

In the technique of PTL 1, a car is arranged in response to a call by the autonomous mobile robot, which is an external apparatus, regardless of the operation condition of the car. Therefore, there is a possibility that the space in a car in an operating state is occupied by the autonomous mobile robot that has already ridden, and, in this case, there is a possibility that the efficiency of riding by users decreases.

The present disclosure has been made to solve the problem as described above, and an object thereof is to provide a technique capable of arranging a car in response to a call from an external apparatus without impairing the convenience of users.

An elevator system according to the present disclosure is configured to be capable of accepting an internal call made by a user operating an elevator operating panel and an external call made from an external apparatus using a communication network. The elevator system includes an elevator number assignment unit configured to assign a car to be an arranged-car candidate to the internal call or the external call from among one or more cars, and a car operation condition judgment unit configured to, when the external call is accepted, execute an operation condition judgment process for judging whether each of the one or more cars is in an operating state or in a non-operating state. The elevator number assignment unit is configured to, in response to a result of the judgment by the operation condition judgment process, execute an external call assignment process for preferentially assigning a car in the non-operating state as the arranged-car candidate over a car in the operating state.

An elevator car assignment method for, in an elevator system configured to be capable of accepting an internal call made by a user operating an elevator operating panel and an external call made from an external apparatus using a communication network, assigning a car to be an arranged-car candidate to the external call from among one or more cars, according to the present disclosure is configured to accept the external call, judge whether each of the one or more cars is in an operating state or in a non-operating state, and execute an external call assignment process for preferentially assigning a car in the non-operating state as the arranged-car candidate over a car in the operating state.

### Advantageous Effects

According to an elevator system and a car assignment method of the present disclosure, it is judged whether each of one or more cars is in an operating state or in a non-operating state, and a car in the non-operating state is preferentially assigned as an arranged-car candidate over a car in the operating state. Thus, since a car in the non-operating state is preferentially assigned to an external call, it becomes possible to arrange a car in response to a call from an external apparatus without impairing the convenience of users who make internal calls.

### BRIEF DESCRIPTION OF DRAWINGS

FIG. 1 is a configuration diagram of an elevator system 100 according to a first embodiment;

FIG. 2 is a block diagram showing an internal configuration of the elevator system 100 of the first embodiment;

FIG. 3 is a configuration diagram of the elevator management apparatus in the elevator system according to a first embodiment;

FIG. 4 is a flowchart showing a routine of a process executed in the elevator management apparatus 5 of the first embodiment;

FIG. 5 is a diagram showing a modification of hardware resources of the elevator management apparatus 5;

FIG. 6 is a block diagram showing an internal configuration of an elevator system 100 of a second embodiment;

FIG. 7 is a flowchart showing a routine of a process executed in the elevator management apparatus 5 of the second embodiment;

FIG. 8 is a block diagram showing an internal configuration of an elevator system 100 of a third embodiment;

FIG. 9 is a diagram showing an example of a relationship among a car arrangement quota, the number of operating cars, and availability of car arrangement;

FIG. 10 is a flowchart showing a routine of a process executed in the elevator management apparatus 5 of the third embodiment;

FIG. 11 is a block diagram showing an internal configuration of an elevator system 100 of a fourth embodiment;

FIG. 12 is a flowchart showing a routine of the car arrangement quota calculation process executed in the elevator management apparatus 5 of the fourth embodiment;

FIG. 13 is a diagram showing an example of the car arrangement quota information;

FIG. 14 is a diagram showing an example of car arrangement quotas calculated for each time zone;

FIG. 15 is a block diagram showing an internal configuration of an elevator system 100 of a fifth embodiment; and

FIG. 16 is a flowchart showing a routine of the external call cancellation process executed in the elevator management apparatus 5 of the fifth embodiment.

### DESCRIPTION OF EMBODIMENTS

Embodiments will be described below with reference to drawings. Components common to the drawings will be given the same reference signs, and duplicated description thereof will be omitted.

### 1. First Embodiment

### 1-1. Configuration of Elevator System

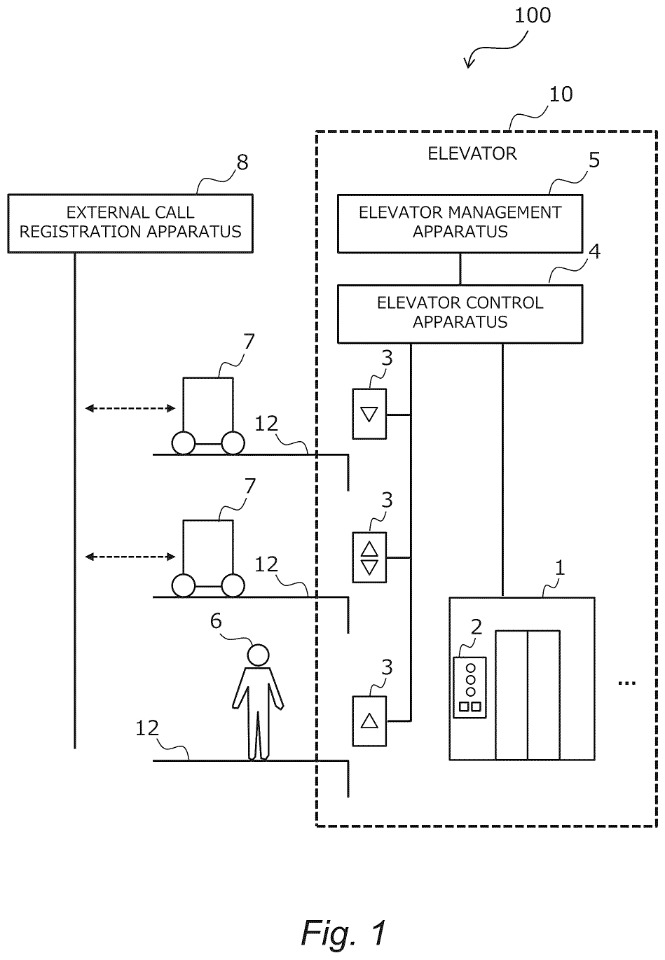

FIG. 1 is a configuration diagram of an elevator system 100 according to a first embodiment.

The elevator system 100 is provided with an elevator 10 and an external call registration apparatus 8. The elevator 10 is configured to accept not only a call by a user 6 but also a call by an external apparatus 7. The “external apparatus 7” here widely includes equipment for making a call using a communication network, for example, a mobility capable of autonomous movement or movement by remote control, such as a robot, building facilities such as an entrance/exit gate or a smartlock, a surveillance camera, a human sensor, and a positioning apparatus.

The elevator 10 is installed, for example, in a building with a plurality of floors. In the building, a hoistway for the elevator 10, which is not shown, is provided. The hoistway is space that is long in the vertical direction through the plurality of floors. On each floor, a hall 12 adjacent to the hoistway is provided.

The elevator 10 is provided with one or more cars 1, a car operating panel 2 installed for each car 1, a hall operating panel 3 installed for each hall 12, an elevator control apparatus 4, and an elevator management apparatus 5. The one or more cars 1 are apparatuses for transporting the user 6 of the elevator 10 and the external apparatus 7 among the plurality of floors by traveling in the hoistway in the vertical direction. The elevator 10 of the first embodiment is provided with, for example, three cars 1 of Elevator No. 1 to Elevator No. 3.

Inside of each car 1, the car operating panel 2 is provided. On the car operating panel 2, various kinds of buttons for performing car door opening and closing operations and an operation of specifying a destination floor are arranged. The hall operating panel 3 is an apparatus for accepting a hall call operation by the user 6. The plurality of hall operating panels 3 are each installed on respective surfaces of walls of the plurality of halls 12.

The elevator control apparatus 4 is an apparatus that controls operation of the elevator 10 based on a call accepted by any of the car operating panels 2 or hall operating panels 3. The call accepted by any of the car operating panels 2 or hall operating panels 3 will be hereinafter referred to as an “internal call”. When any of the car operating panels 2 or hall operating panels 3 accepts an internal call, the elevator control apparatus 4 regards both cars 1 in the operating state and cars 1 in the non-operating state as arranged-car candidates, and assigns any one car from among the arranged-car candidates. The “operating state” of a car here is a state in which the car is operating in response to an assigned call, and a state of the door being opened for getting on and off, a state of the car being traveling, and the like are exemplified. On the other hand, the “non-operating state” of a car is a state in which a call is not assigned to the car, and a state of the car waiting for the door to be closed, and the like are exemplified. As for an operation of assigning a car to an internal call, detailed description thereof will be omitted because a well-known assignment operation can be applied. The elevator control apparatus 4 is arranged, for example, at an upper part or a lower part of the hoistway. For example, when a machine room for the elevator 10 is provided at an upper part of the hoistway, the elevator control apparatus 4 may be arranged in the machine room.

The elevator management apparatus 5 is an apparatus that controls operation of the elevator 10 based on a call registered with the external call registration apparatus 8 from the external apparatus 7. The call registered with the external call registration apparatus 8 from the external apparatus 7 will be hereinafter referred to as an “external call”. The elevator management apparatus 5 is arranged, for example, at an upper part or a lower part of the hoistway. For example, when the machine room for the elevator 10 is provided at an upper part of the hoistway, the elevator control apparatus 4 may be arranged in the machine room. Details of functions of the elevator management apparatus 5 will be described later.

The external call registration apparatus 8 is an apparatus that registers an external call received from the external apparatus 7 via a communication network and transmits the external call and registration information to the elevator management apparatus 5. The method of a communication network between the external call registration apparatus 8 and the elevator management apparatus 5 is not limited. For example, when the external call registration apparatus 8 is arranged in a server at a remote place, a general-purpose communication method such as the Internet or near field communication may be adopted. Further, when the external call registration apparatus 8 is arranged in the machine room for the elevator 10, the external call registration apparatus 8 may be connected to the elevator management apparatus 5 via wired communication.

### 1-2. Functions of Elevator System of First Embodiment

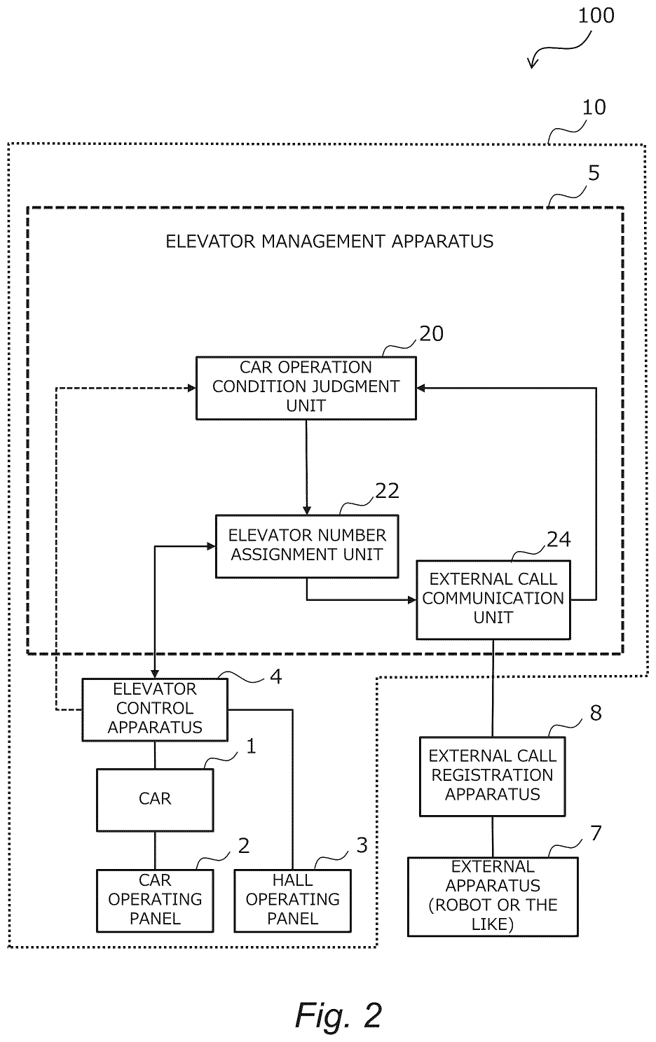

FIG. 2 is a block diagram showing an internal configuration of the elevator system 100 of the first embodiment. The elevator management apparatus 5 is provided with a car operation condition judgment unit 20, an elevator number assignment unit 22, and an external call communication unit 24 as internal functional blocks thereof. The car operation condition judgment unit 20 is a functional block for executing an operation condition judgment process for judging whether each of the one or more cars 1 is in the operating state or in the non-operating state, based on information received from the elevator control apparatus 4. The car operation condition judgment unit 20 may be configured to continuously judge the operation condition of each car 1 by the operation condition judgment process or may be configured to execute the operation condition judgment process in response to the external call communication unit 24 described later receiving an external call. The car operation condition judgment unit 20 transmits judgment result information to the elevator number assignment unit 22.

The elevator number assignment unit 22 is a functional block for performing a process for assigning a car 1 to an external call. This process will be hereinafter referred to as an “external call assignment process”. In the external call assignment process, the elevator number assignment unit 22 preferentially assigns one or more cars in the non-operating state as arranged-car candidates over cars in the operating state, based on the judgment result information received from the car operation condition judgment unit 20. More specifically, the elevator number assignment unit 22 excludes the cars in the operating state among the one or more cars 1 from the arranged-car candidates and assigns only the cars in the non-operating state as the arranged-car candidates. Then, the elevator number assignment unit 22 assigns a car corresponding to the external call from among the arranged-car candidates including only the cars in the non-operating state.

The external call communication unit 24 is a functional block for transmitting/receiving information related to an external call, to/from the external call registration apparatus 8. The external call communication unit 24 receives, for example, external call registration information including that an external call has been registered, from the external call registration apparatus 8. Further, the external call communication unit 24 transmits information about arrangement of a car 1 for the external call, to the external call registration apparatus 8.

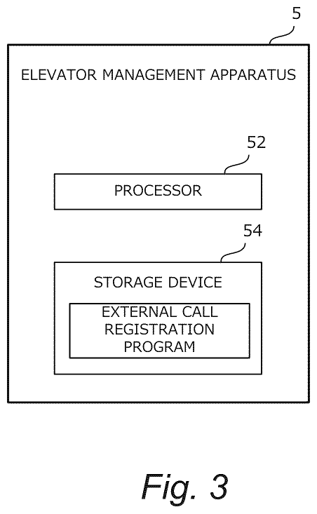

FIG. 3 is a configuration diagram of the elevator management apparatus in the elevator system according to a first embodiment. The elevator management apparatus 5 is provided with a processor 52 and a storage device 54.

The processor 52 executes various kinds of processes. The processor 52 is, for example, a microcomputer. In the storage device 54, various kinds of information are stored. As the storage device 54, a volatile memory, a non-volatile memory, or the like is exemplified. In the storage device 54, an external call registration program is stored. By the processor 52 executing the external call registration program, the operation condition judgment process and the external call assignment process in the elevator management apparatus 5 are realized. Further, in the storage device 54, the judgment result information, the external call registration information, and the car arrangement information are stored as various kinds of data.

### 1-3. Specific Process Executed in Elevator Management Apparatus 5 of First Embodiment

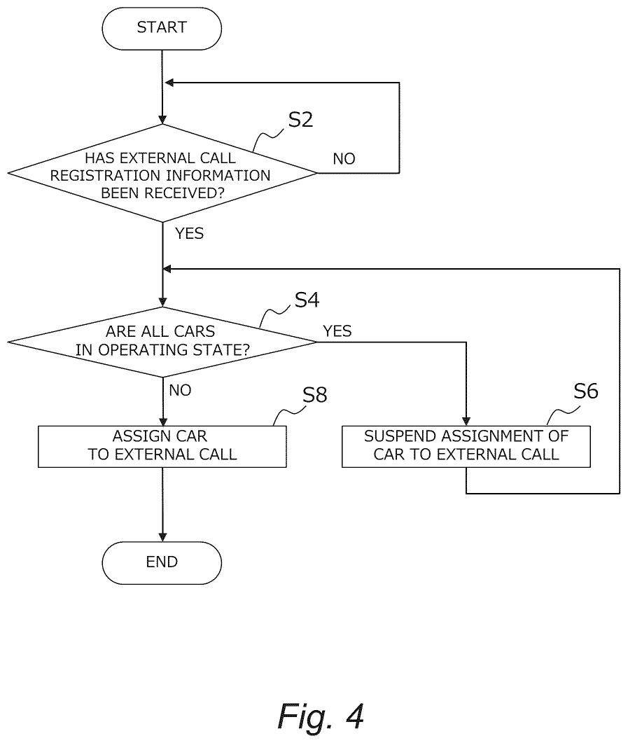

FIG. 4 is a flowchart showing a routine of a process executed in the elevator management apparatus 5 of the first embodiment. The routine shown in FIG. 4 is executed by the processor 52 of the elevator management apparatus 5 when the external call registration program is executed. This flowchart also indicates a part of a car assignment method according to an embodiment of the present disclosure.

At step S2 of the routine shown in FIG. 4, it is judged whether an external call by the external apparatus 7 has been registered or not. Here, the external call communication unit 24 judges whether external call registration information has been received from the external call registration apparatus 8 or not. As a result, if a result of the judgment is negative, the judgment of step S2 is repeatedly executed. On the other hand, if the result of the judgment of step S2 is positive, the process proceeds to step S4.

At step S4, it is judged by the operation condition judgment process executed by the car operation condition judgment unit 20 whether each of the one or more cars is in the operating state or not. As a result, if all the cars are in the operating state, the process proceeds to step S6; and, if there is at least one car in the non-operating state, the process proceeds to step S8.

In the processing of step S6, the elevator number assignment unit 22 suspends assignment of a car to the external call because there is not a car in the non-operating state to be set as an arranged-car candidate. Further, the elevator number assignment unit 22 transmits information showing that assignment to the external call is suspended, to the external call communication unit 24. The external call communication unit 24 notifies the external apparatus 7 to wait at the hall 12. When the processing of step S6 is performed, the process returns to the processing of step S4 again.

On the other hand, in the processing of step S8, the elevator number assignment unit 22 assigns a car corresponding to the external call from among cars in the non-operating state set as arranged-car candidates. Further, the elevator number assignment unit 22 transmits information about an assigned elevator number assigned to the external call, to the external call communication unit 24. The external call communication unit 24 notifies the external apparatus 7 of the assigned elevator number. When the processing of step S8 is performed, the present routine is ended.

According to the process as described above, when an external call from the external apparatus 7 is registered, cars in the operating state are excluded from arranged-car candidates, and only cars in the non-operating state are caused to be the arranged-car candidates. Thereby, when there is not a car in the non-operating state, a car corresponding to the external call is not assigned. Thereby, an internal call is preferentially assigned over an external call, and, therefore, it is possible to prevent the convenience of general users who make internal calls from being impaired.

Further, since, when there is a car in the non-operating state, the car is assigned to an external call, it becomes possible to also respond to an external call of the external apparatus 7 without impairing the convenience of general users.

### 1-4. Modification of First Embodiment

An aspect of modifying the elevator system 100 of the first embodiment as below may be applied. The modification below can also be applied to elevator systems of the other embodiments described later.

The elevator number assignment unit 22 may have a function of spooling an external call. In this case, as soon as it is judged by the car operation condition judgment unit 20 that there is a car in the non-operating state, the elevator number assignment unit 22 can assign a spooled external call to the car in the non-operating state.

When the external apparatus 7 does not have a display function, a configuration is also possible in which a notification from the external call communication unit 24 to the external apparatus 7 is displayed on an indicator installed at the hall 12.

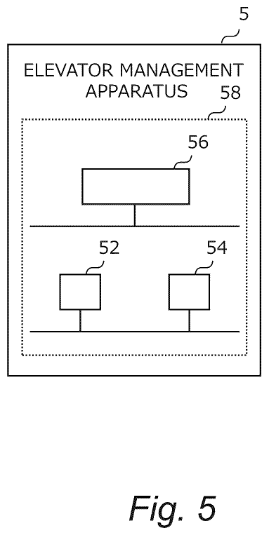

FIG. 5 is a diagram showing a modification of hardware resources of the elevator management apparatus 5. In the example shown in FIG. 5, the elevator management apparatus 5 is provided, for example, with the processor 52, the storage device 54, and processing circuitry 58 including dedicated hardware 56. FIG. 5 shows an example in which a part of the functions of the elevator management apparatus 5 is realized by the dedicated hardware 56. All of the functions of the elevator management apparatus 5 may be realized by the dedicated hardware 56. As the dedicated hardware 56, a single circuit, a composite circuit, a programmed processor, a parallel-programmed processor, an ASIC, an FPGA, or a combination thereof can be adopted.

### Second Embodiment

### 2-1. Characteristic Functions of Elevator System of Second Embodiment

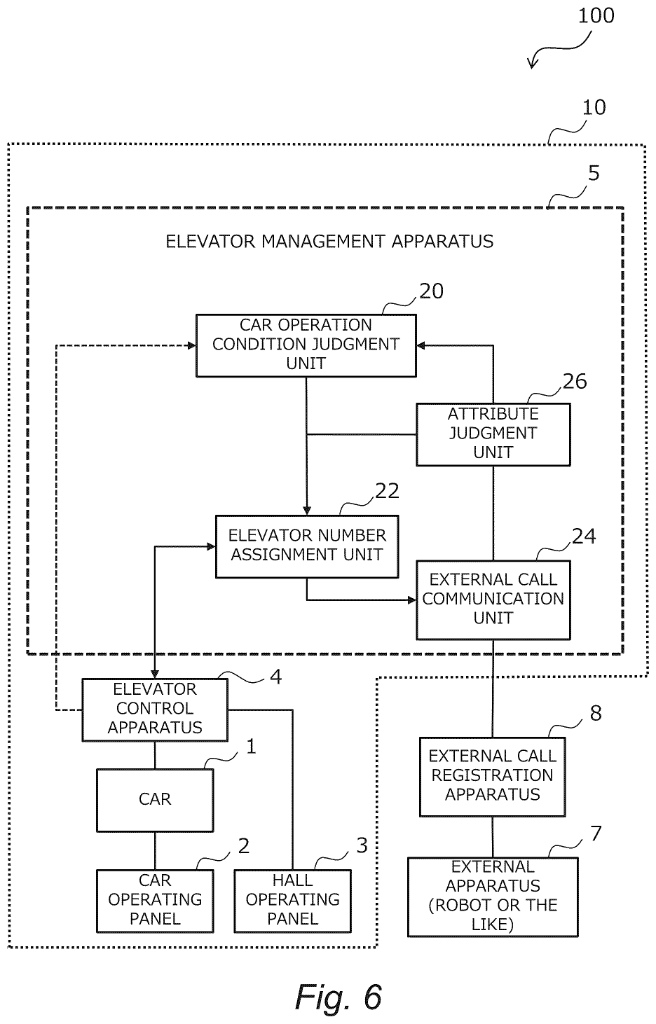

FIG. 6 is a block diagram showing an internal configuration of an elevator system 100 of a second embodiment. In addition to the configuration of the elevator management apparatus 5 of the first embodiment, the elevator management apparatus 5 of the second embodiment is further provided with an attribute judgment unit 26.

The attribute judgment unit 26 is a functional block for judging whether the attribute of an external call is to be prioritized or not. There is also such an external call that is as urgent as an internal call by a general user. Such an external call to be prioritized is an external call for users that is registered, for example, from a guidance robot accompanying a user, a delivery robot that provides room services and the like, a personal mobility, a smartphone, or a smart device.

The external call communication unit 24 transmits external call registration information received from the external call registration apparatus 8, to the attribute judgment unit 26. The external call registration information includes attribute information showing whether the external call is an external call to be prioritized or not. The attribute judgment unit 26 judges whether the attribute of the external call is to be prioritized or not from the received external call registration information. This process will be hereinafter referred to as an “attribute judgment process”.

For an external call to be prioritized, it is allowed to ride together with general users to ensure urgency that is equal to that of an internal call. Specifically, if the attribute of an external call is judged to be prioritized in the attribute judgment process, the elevator number assignment unit 22 sets both cars in the operating state and cars in the non-operating state as arranged-car candidates. Then, the elevator number assignment unit 22 assigns a car corresponding to the external call from among these arranged-car candidates.

On the other hand, if the attribute of the external call is judged not to be prioritized in the attribute judgment process, the elevator number assignment unit 22 excludes the cars in the operating state from the arranged-car candidates and sets only the cars in the non-operating state as arranged-car candidates. Then, the elevator number assignment unit 22 assigns a car corresponding to the external call from among the arranged-car candidates including only the cars in the non-operating state.

According to the operation of the elevator system 100 of the second embodiment as described above, as for an external call to be prioritized, even cars in the operating state are set as arranged-car candidates. Thereby, appropriate car arrangement corresponding to each of purposes of the external apparatus 7 becomes possible.

### 2-2. Specific Process Executed in Elevator Management Apparatus 5 of Second Embodiment

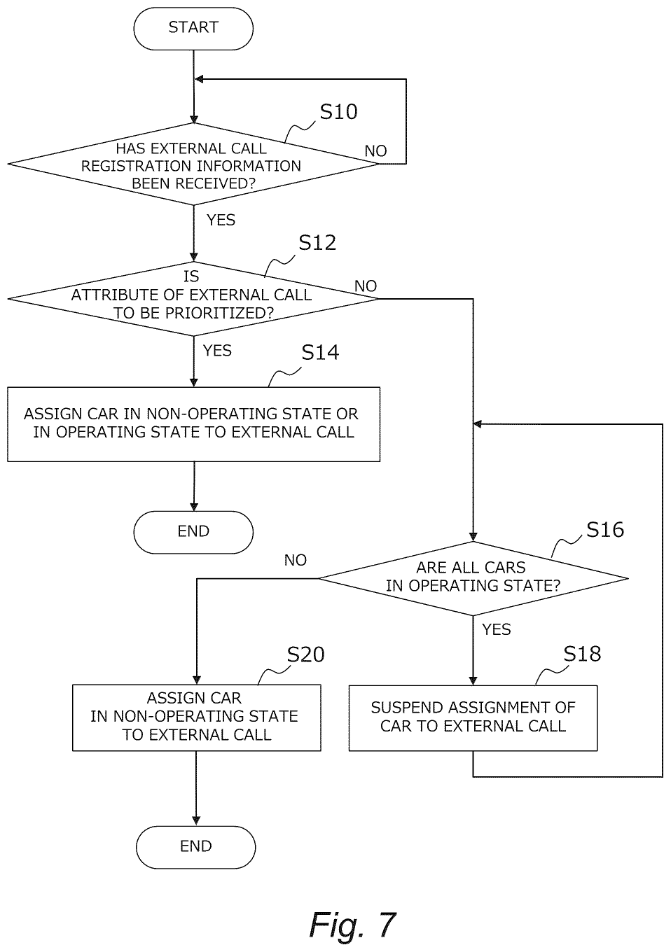

FIG. 7 is a flowchart showing a routine of a process executed in the elevator management apparatus 5 of the second embodiment. The routine shown in FIG. 7 is executed by the processor 52 of the elevator management apparatus 5 when the external call registration program is executed. This flowchart also indicates a part of the car assignment method according to the embodiment of the present disclosure.

At step S10 of the routine shown in FIG. 7, it is judged whether an external call of the external apparatus 7 has been registered or not. Here, processing similar to the processing of step S2 of the routine shown in FIG. 4 is executed. As a result, if a result of a judgment is negative, the judgment of step S10 is repeatedly executed. On the other hand, if the result of the judgment of step S10 is positive, the process proceeds to step S12.

At step S12, it is judged by the attribute judgment process executed by the attribute judgment unit 26 whether the attribute of the external call registered at step S10 is to be prioritized or not. Here, the attribute judgment unit 26 judges whether attribute information included in external call registration information is to be prioritized or not. As a result, if a result of the judgment is positive, the process proceeds to step S14; and, if the result of the judgment is negative, the process proceeds to step S16.

At step S14, the elevator number assignment unit 22 sets both cars in the operating state and cars in the non-operating state as arranged-car candidates. Then, the elevator number assignment unit 22 assigns a car corresponding to the external call from among the cars in the operating state and in the non-operating state set as the arranged-car candidates. When the processing of step S14 is completed, the present routine is ended.

At step S16, it is judged by the operation condition judgment process executed by the car operation condition judgment unit 20 whether each of the one or more cars is in the operating state or not. As a result, if all the cars are in the operating state, the process proceeds to step S18; and, if there is at least one car in the non-operating state, the process proceeds to step S20.

At step S18, the elevator number assignment unit 22 suspends assignment of a car to the external call because there is not a car in the non-operating state to be set as an arranged-car candidate. Further, the elevator number assignment unit 22 transmits information showing that assignment to the external call is suspended, to the external call communication unit 24. The external call communication unit 24 notifies the external apparatus 7 to wait at the hall 12. When the processing of step S18 is performed, the process returns to the processing of S16 again.

On the other hand, in the processing of step S20, the elevator number assignment unit 22 sets the cars in the non-operating state as the arranged-car candidates, and assigns a car corresponding to the external call from among the arranged-car candidates. Further, the elevator number assignment unit 22 transmits information about an assigned elevator number assigned to the external call, to the external call communication unit 24. The external call communication unit 24 notifies the external apparatus 7 of the assigned elevator number. When the processing of step S20 is performed, the present routine is ended.

According to the process as described above, when an external call is registered from the external apparatus 7, the external call is preferentially assigned equally to an internal call if the external call is a call to be prioritized. Thereby, appropriate car arrangement corresponding to each of purposes of the external apparatus 7 becomes possible.

### 2-3. Modification of Second Embodiment

An aspect of modifying the elevator system 100 of the second embodiment as below may be applied. The modification below can also be applied to elevator systems of the other embodiments.

The attribute judgment process may be configured to not only judge whether the attribute of an external call is to be prioritized or not but also judge priority order in more detail among attributes to be prioritized. For example, when the external apparatus 7 is a piece of equipment such as a personal mobility, a wearable smart device, or a wheelchair possessed or used by a user, the attribute is given the highest priority among attributes to be prioritized. Further, when the external apparatus 7 is a robot, the priority of the attributes of a guidance robot accompanying a user and a delivery robot for food delivery are set to “high”, the priority of a package delivery robot is set to “medium”, and the priority of a cleaning robot is set to “low”. Further, when the external apparatus 7 is a security robot, the priority is set to “low” during regular patrol and set to “high” in the case of emergency. In the case of assigning cars corresponding to external calls, the elevator number assignment unit 22 assigns the cars in order of priority of the external calls by changing car arrangement order. According to such a process, flexible assignment according to priority of external calls becomes possible.

### Third Embodiment

### 3-1. Characteristic Functions of Elevator System of Third Embodiment

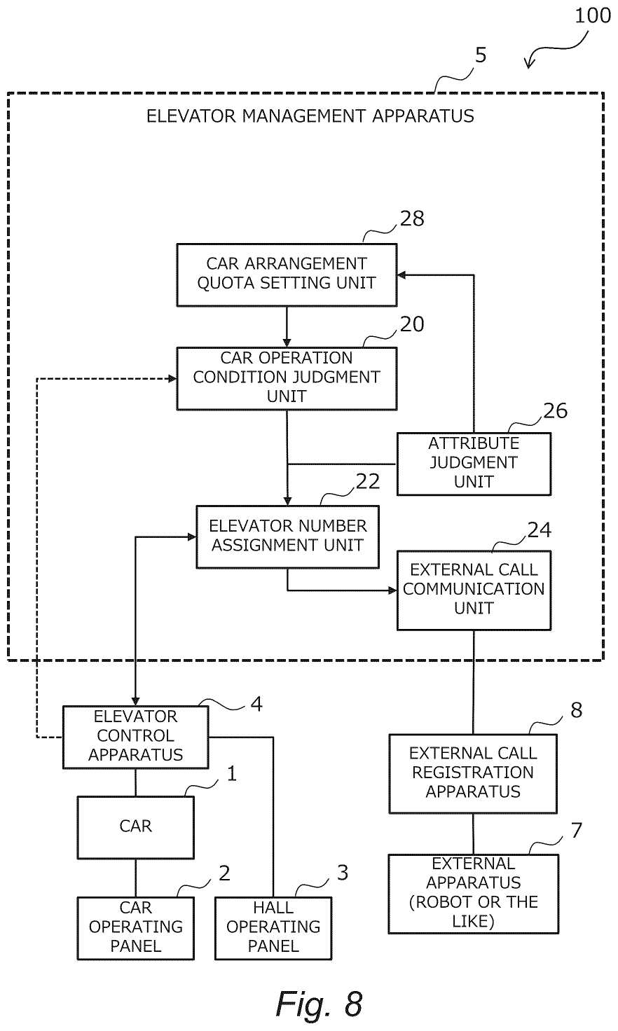

FIG. 8 is a block diagram showing an internal configuration of an elevator system 100 of a third embodiment. In addition to the configuration of the elevator management apparatus 5 of the second embodiment, the elevator management apparatus 5 of the third embodiment is further provided with a car arrangement quota setting unit 28.

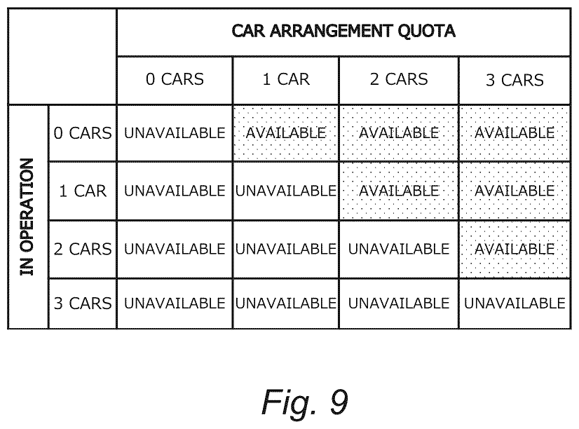

The car arrangement quota setting unit 28 is a functional block for executing a car arrangement quota setting process for setting the number of cars that can be operated at the same time, among the one or more cars 1 provided for the elevator 10. FIG. 9 is a diagram showing an example of a relationship among a car arrangement quota, the number of operating cars, and availability of car arrangement. As shown in FIG. 9, if the car arrangement quota is set to one for an elevator provided with three cars, car arrangement is available when the number of cars in the operating state is zero, but car arrangement becomes unavailable when the number of cars in the operating state is one or more. Similarly, when the car arrangement quota is set to two, car arrangement is available when the number of cars in the operating state is one or zero, but car arrangement becomes unavailable when the number of cars in the operating state is two or more. In the car arrangement quota setting process, the car arrangement quota setting unit 28 sets the car arrangement quota, for example, to a predetermined number. Or alternatively, the car arrangement quota setting unit 28 sets the car arrangement quota, for example, to a number corresponding to a predetermined rate relative to the total number of cars. The elevator number assignment unit 22 assigns a car corresponding to an external call within the range of a car arrangement quota.

According to the operation of the elevator system 100 of the third embodiment as described above, since assignment of a car to an external call is limited to be within a car arrangement quota, it is possible to prevent the convenience of general users from being impaired.

### 3-2. Specific Process Executed in Elevator Management Apparatus 5 of Third Embodiment

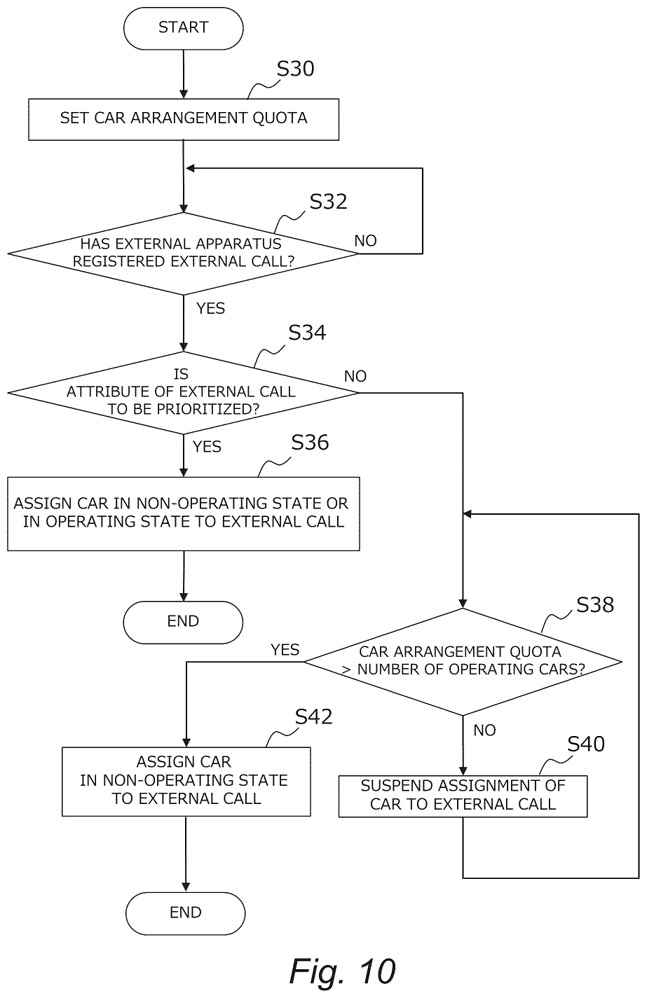

FIG. 10 is a flowchart showing a routine of a process executed in the elevator management apparatus 5 of the third embodiment. The routine shown in FIG. 10 is executed by the processor 52 of the elevator management apparatus 5 when the external call registration program is executed. This flowchart also indicates a part of the car assignment method according to the embodiment of the present disclosure.

At step S30 of the routine shown in FIG. 10, a car arrangement quota is set. Here, in the car arrangement quota setting process executed by the car arrangement quota setting unit 28, the car arrangement quota is set to a predetermined number.

When the processing of step S30 is executed, the process proceeds to step S32. At steps S32, S34, and S36, processes similar to those of steps S10, S12, and S14 of the routine shown in FIG. 7 are executed. If the result of the judgment is negative in the processing of step S34, the process proceeds to step S38.

At step S38, the elevator number assignment unit 22 judges whether the set car arrangement quota is larger than the number of operating cars or not. As a result, if a result of the judgment is negative, it is determined that arrangement of a car for the external call is unavailable, and the process proceeds to step S40. On the other hand, if the result of the judgment is positive, it is determined that arrangement of a car for the external call is available, and the process proceeds to step S42.

At step S40, the elevator number assignment unit 22 suspends assignment of a car to the external call. Further, the elevator number assignment unit 22 transmits information showing that assignment to the external call is suspended, to the external call communication unit 24. The external call communication unit 24 notifies the external apparatus 7 to wait at the hall 12.

When the set car arrangement quota is zero, suspension of assignment to the external call is continued even if the operation condition of a car transitions to the non-operating state. In this case, the elevator number assignment unit 22 transmits information showing that the car arrangement quota is zero, to the external call communication unit 24. The external call communication unit 24 notifies the external apparatus 7 that the condition does not transition to a state in which car arrangement is available. When the processing of step S40 is performed, the process returns to the processing of S38 again.

On the other hand, in the processing of step S42, the elevator number assignment unit 22 sets cars in the non-operating state as the arranged-car candidates, and assigns a car corresponding to the external call from among the arranged-car candidates. Further, the elevator number assignment unit 22 transmits information about an assigned elevator number assigned to the external call, to the external call communication unit 24. The external call communication unit 24 notifies the external apparatus 7 of the assigned elevator number. When the processing of step S42 is performed, the present routine is ended.

According to the process as described above, it is also possible to change the car arrangement quota setting according to the situation of usage by users, a time zone, or the like. For example, it is possible to take a measure of reducing the car arrangement quota for particular time zones during which crowdedness is expected. Thereby, it becomes possible to perform appropriate car arrangement according to the situation of usage by users.

### Fourth Embodiment

### 4-1. Characteristic Functions of Elevator System of Fourth Embodiment

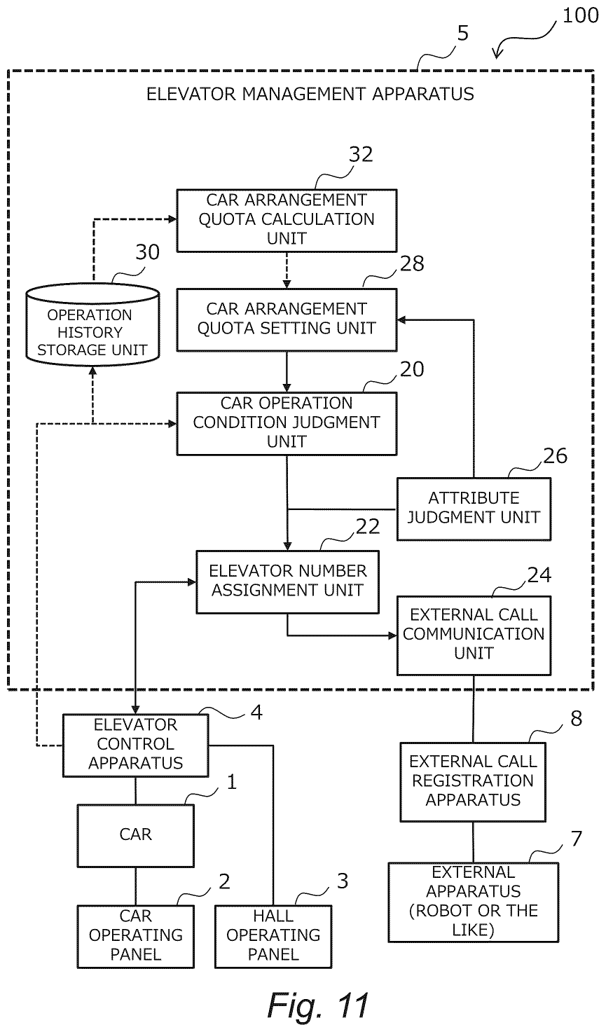

FIG. 11 is a block diagram showing an internal configuration of an elevator system 100 of a fourth embodiment. In addition to the configuration of the elevator management apparatus 5 of the third embodiment, the elevator management apparatus 5 of the fourth embodiment is further provided with an operation history storage unit 30 and a car arrangement quota calculation unit 32.

The operation history storage unit 30 is a functional block for storing operation history information in which an operation history of each of the one or more cars 1 is associated with time. The operation history storage unit 30 is arranged, for example, in the storage device 54 of the elevator management apparatus. Or alternatively, the operation history storage unit 30 may be arranged in a server at a remote place.

The car arrangement quota calculation unit 32 is a functional block for reading the operation history information from the storage device 54 to calculate a car arrangement quota. The car arrangement quota calculation unit 32 sets a car arrangement quota, for example, by executing a car arrangement quota calculation process below in the processing of step S30 of the flowchart shown in FIG. 10.

### 4-2. Specific Process Executed in Elevator Management Apparatus 5 of Fourth Embodiment

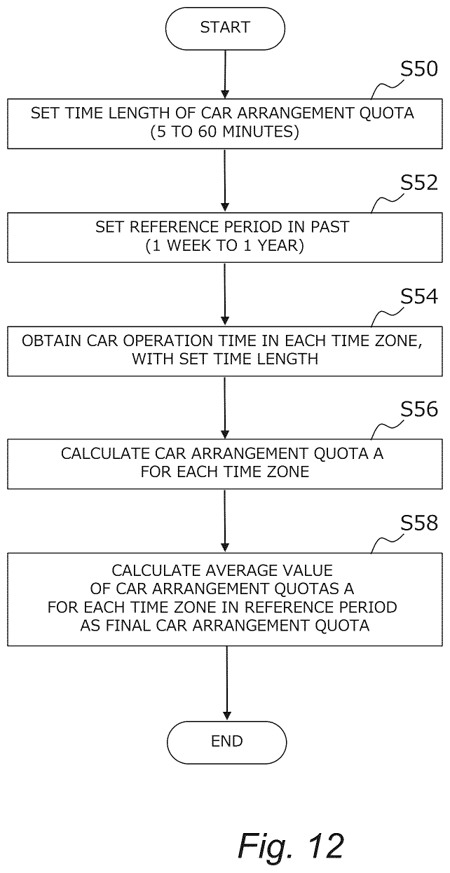

FIG. 12 is a flowchart showing a routine of the car arrangement quota calculation process executed in the elevator management apparatus 5 of the fourth embodiment. The routine shown in FIG. 12 is executed by the processor 52 of the elevator management apparatus 5.

At step S50 of the routine shown in FIG. 12, the car arrangement quota calculation unit 32 sets a time length at the time of setting a car arrangement quota. The time length here is set to, for example, five minutes to sixteen minutes.

Next, at step S52, the car arrangement quota calculation unit 32 sets a predetermined reference period in the past. The reference period is a period of, for example, one week to one year. At step S54, the car arrangement quota calculation unit 32 reads operation history information corresponding to the set reference period, and obtains operation time for each time zone with the set time length.

At step S56, the car arrangement quota calculation unit 32 calculates a car arrangement quota A for each time zone of each day during the reference period. Here, the car arrangement quota calculation unit 32 calculates the car arrangement quota A, for example, using Formula (1) below.

$$Car arrangement quota A = total number of cars - ( total operation time of cars / time length ) \qquad ( 1 )$$

For example, when the total number of cars is three, the time length is one hour, and operation times of cars from 10:00 to 11:00 on July 1 are each ten minutes, fifteen minutes, and thirty minutes, the car arrangement quota A calculated using Formula (1) is as follows.

$$Car arrangement quota A = 3 - ( ( 10 + 15 + 30 ) / 60 ) = 2.08 cars$$

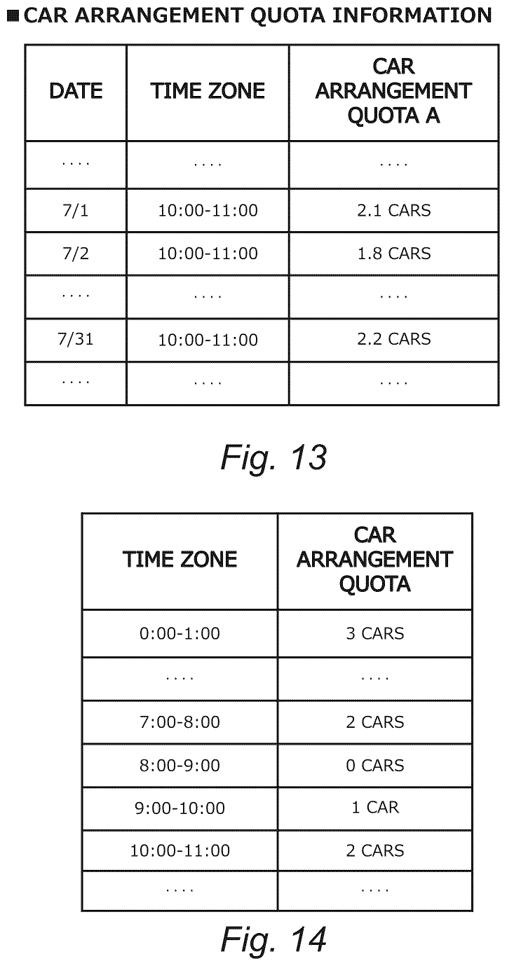

Information about the calculated car arrangement quota A is stored into the storage device 54 as car arrangement quota information. FIG. 13 is a diagram showing an example of the car arrangement quota information. In the example shown in FIG. 13, each calculated car arrangement quota A is stored in association with a date and a time zone.

At step S58, the car arrangement quota calculation unit 32 calculates an average value of the car arrangement quotas A for each time zone in the reference period as a final car arrangement quota, using the car arrangement quota information. FIG. 14 is a diagram showing an example of car arrangement quotas calculated for each time zone. The car arrangement quota calculation unit 32 sets a different car arrangement quota for each time zone.

According to the operation of the elevator system 100 of the fourth embodiment as described above, it is possible to reflect the situation of usage by users in each time zone on the car arrangement quota. Thereby, the car arrangement quota is reduced for a crowded time zone, so that it is possible to perform appropriate car arrangement according to the situation of usage without impairing the convenience of users.

### Fifth Embodiment

### 5-1. Characteristic Functions of Elevator System of Fifth Embodiment

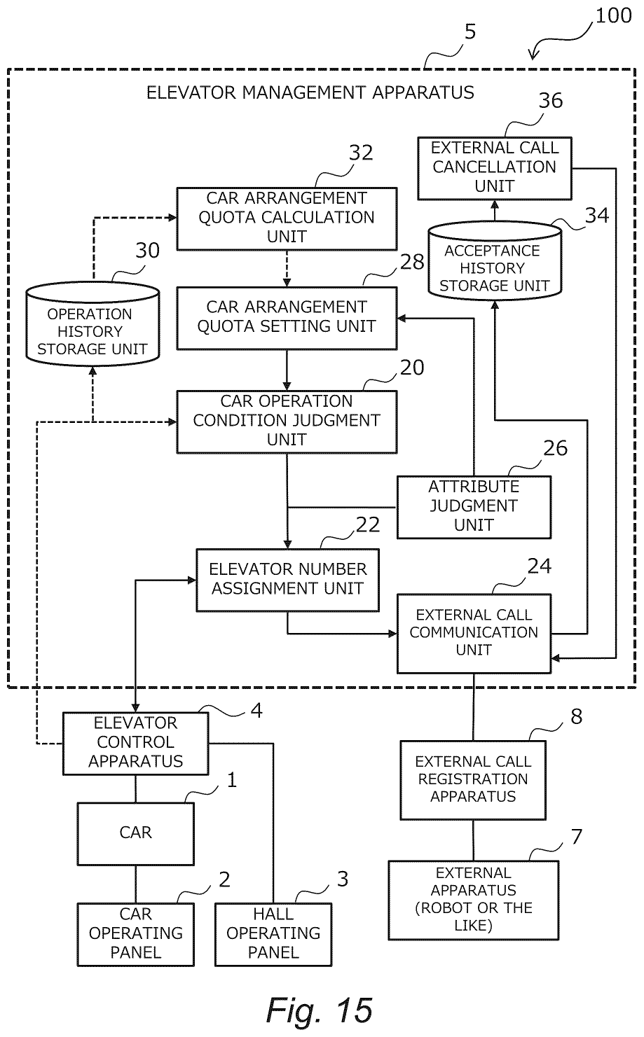

FIG. 15 is a block diagram showing an internal configuration of an elevator system 100 of a fifth embodiment. In addition to the configuration of the elevator management apparatus 5 of the fourth embodiment, the elevator management apparatus 5 of the fifth embodiment is further provided with an acceptance history storage unit 34 and an external call cancellation unit 36.

The acceptance history storage unit 34 is a functional block for storing history information about external calls accepted by the external call communication unit 24. The acceptance history storage unit 34 is arranged, for example, in the storage device 54 of the elevator management apparatus 5. Or alternatively, the acceptance history storage unit 34 may be arranged in a server at a remote place.

The external call cancellation unit 36 is a functional block for canceling a duplicated external call using the history information stored in the acceptance history storage unit 34. This process will be hereinafter referred to as an “external call cancellation process”. A specific process of the external call cancellation process will be described below.

### 5-2. Specific Process Executed in Elevator Management Apparatus 5 of Fifth Embodiment

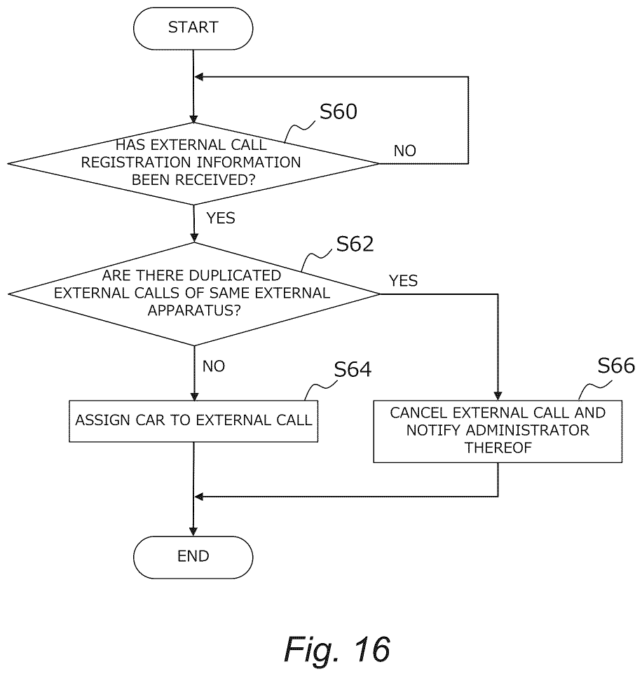

FIG. 16 is a flowchart showing a routine of the external call cancellation process executed in the elevator management apparatus 5 of the fifth embodiment. The routine shown in FIG. 16 is executed by the processor 52 of the elevator management apparatus 5. This flowchart also indicates a part of the car assignment method according to the embodiment of the present disclosure.

At step S60 of the routine shown in FIG. 16, it is judged whether an external call of the external apparatus 7 has been registered or not. Here, the external call communication unit 24 judges whether external call registration information has been received from the external call registration apparatus 8 or not. As a result, if a result of the judgment is negative, the judgment of step S50 is repeatedly executed. On the other hand, if the result of the judgment of step S60 is positive, the process proceeds to step S62.

At step S62, it is judged whether there are duplicated external calls of the same external apparatus or not. Here, the external call cancellation unit 36 judges whether or not an external call has been continuously registered by the same external apparatus a predetermined number of times set in advance or more times, based on the history information stored in the acceptance history storage unit 34. The predetermined number of times here is a judgment threshold for judging abnormality of equipment. As a result, if a result of the judgment is negative, the process proceeds to step S64. On the other hand, if the result of the judgment is negative, it is determined that abnormality has occurred in some piece of equipment, and the process proceeds to step S66.

At step S64, the elevator number assignment unit 22 assigns a car corresponding to the external call from among cars in the non-operating state set as arranged-car candidates. Further, the elevator number assignment unit 22 transmits information about an assigned elevator number assigned to the external call, to the external call communication unit 24. The external call communication unit 24 notifies the external apparatus 7 of the assigned elevator number. When the processing of step S64 is performed, the present routine is ended.

At step S66, the external call cancellation unit 36 cancels the external call and notifies an administrator of the elevator system 100 thereof. When the processing of step S66 is performed, the present routine is ended.

According to the process as described above, it is possible to prevent negative effects on external calls due to abnormality of equipment or the like.

### 5-3. Modification of Fifth Embodiment

An aspect of modifying the elevator system 100 of the fifth embodiment as below may be applied.

In addition to the configuration of the elevator management apparatus 5 of the first, second, or third embodiment, the elevator management apparatus 5 of the fifth embodiment may be further provided with the acceptance history storage unit 34 and the external call cancellation unit 36.

### REFERENCE SIGNS LIST

1 car, 2 car operating panel, 3 hall operating panel, 4 elevator control apparatus, 5 elevator management apparatus, 6 user, 7 external apparatus, external call registration apparatus, 10 elevator, 12 hall, 20 car operation condition judgment unit, 22 elevator number assignment unit, 24 external call communication unit, 26 attribute judgment unit, 28 car arrangement quota setting unit, 30 operation history storage unit, 32 car arrangement quota calculation unit, 34 acceptance history storage unit, 36 external call cancellation unit, 52 processor, 54 storage device, 56 dedicated hardware, 58 processing circuitry, 100 elevator system

1. An elevator system configured to be capable of accepting an internal call made by a user operating an elevator operating panel and an external call made from an external apparatus separate from the elevator operating panel using a communication network and configured to assign a car to be an arranged-car candidate to the internal call or the external call from among one or more cars, the elevator system comprising processing circuitry, the processing circuitry being configured to execute:
an operation condition judgment process for, when the external call is accepted, judging whether each of the one or more cars is in an operating state or in a non-operating state;
an attribute judgment process for, when the external call is accepted, judging an attribute related to priority of the external apparatus; and
an external call assignment process for, in response to a result of the judgment by the operation condition judgment process, preferentially assigning a car in the non-operating state as the arranged-car candidate over a car in the operating state; wherein
the processing circuitry is configured to, in the external call assignment process, decide whether or not to assign the car in the operating state as the arranged-car candidate, according to the attribute.

2. The elevator system according to claim 1, wherein
the processing circuitry is configured to, in the external call assignment process, exclude the car in the operating state from becoming the arranged-car candidate.

3. (canceled)

4. The elevator system according to claim 1, wherein
the processing circuitry is configured to, when the external call is accepted, execute a car arrangement quota setting process for setting a car arrangement quota for the one or more cars, and wherein
the processing circuitry is configured to, in the external call assignment process, assign a car in the non-operating state as the arranged-car candidate if the car arrangement quota is larger than the number of cars in the operating state.

5. The elevator system according to claim 4, wherein
the processing circuitry is configured to, in the car arrangement quota setting process, obtain operation history information in which an operation history of each of the one or more cars is associated with time and set the car arrangement quota for each time zone based on the operation history information.

6. The elevator system according to claim 1, wherein
the processing circuitry is further configured to, when the external call has been continuously accepted from the same external apparatus a predetermined number of times or more, execute an external call cancellation process for canceling the acceptance of the external call.

7. An elevator car assignment method for, in an elevator system configured to be capable of accepting an internal call made by a user operating an elevator operating panel and an external call made from an external apparatus separate from the elevator operating panel using a communication network, assigning a car to be an arranged-car candidate to the external call from among one or more cars, the elevator car assignment method being configured to:
accept the external call;
judge whether each of the one or more cars is in an operating state or in a non-operating state;
judge an attribute related to priority of the external apparatus;
execute an external call assignment process for preferentially assigning a car in the non-operating state as the arranged-car candidate over a car in the operating state; and
in the external call assignment process, decide whether or not to assign the car in the operating state as the arranged-car candidate, according to the attribute.

8. The elevator car assignment method according to claim 7, being configured to, in the external call assignment process, exclude the car in the operating state from becoming the arranged-car candidate.

9. (canceled)

10. The elevator car assignment method according to claim 7, being configured to:
set a car arrangement quota for the one or more cars; and
in the external call assignment process, assign a car in the non-operating state as the arranged-car candidate if the car arrangement quota is larger than the number of cars in the operating state.

11. The elevator car assignment method according to claim 10, being configured to:
at time of setting the car arrangement quota, obtain operation history information in which an operation history of each of the one or more cars is associated with time; and
set the car arrangement quota for each time zone based on the operation history information.

12. The elevator car assignment method according to claim 7, being configured to, when the external call has been continuously accepted from the same external apparatus a predetermined number of times or more, cancel the acceptance of the external call.
